(19) United States
(12) Patent Application Publication
(10) Pub. No.: US 2020/0073290 A1
(43) Pub. Date: Mar. 5, 2020

(54) IMAGE FORMING APPARATUS

(71) Applicant: CANON KABUSHIKI KAISHA, Tokyo (JP)

(72) Inventor: Kunihiko Kitayama, Abiko-shi (JP)

(21) Appl. No.: 16/677,008

(22) Filed: Nov. 7, 2019

Related U.S. Application Data
(63) Continuation of application No. PCT/JP2018/020026, filed on May 24, 2018.

(30) Foreign Application Priority Data
May 26, 2017 (JP) 2017-105062

(51) Int. Cl. G03G 15/10

(52) U.S. Cl. CPC G03G 15/10

(57) ABSTRACT

An image forming apparatus includes a liquid discharge unit and a connection unit. The liquid discharge unit is configured to be attachable to and detachable from an apparatus body. The liquid discharge unit includes an accommodating container configured to accommodate liquid developer, a discharge pipe portion having a liquid discharge port through which the liquid developer in the accommodating container is discharged. The connection unit includes an insertion portion into which the discharge pipe portion is inserted in an insertion direction intersecting a gravity direction, a liquid receiving portion configured to receive the liquid developer falling from the liquid discharge port, and an abutment member. The abutment member abuts on the surface of the discharge pipe portion from below in the gravity direction, that side surface on a downstream side in the insertion direction forms a guide surface configured to guide the liquid developer to the liquid receiving portion.

### CROSS-REFERENCE TO RELATED APPLICATIONS

This application is a Continuation of International Patent Application No. PCT/JP2018/020026, filed May 24, 2018, which claims the benefit of Japanese Patent Application No. 2017-105062, filed May 26, 2017, both of which are hereby incorporated by reference herein in their entirety.

### BACKGROUND OF THE INVENTION

### Field of the Invention

The present invention relates to an electrophotographic image forming apparatus that forms an image using a liquid developer.

### Description of the Related Art

Hitherto, an image forming apparatus that forms an image using a liquid developer including a toner and carrier liquid has been known. The liquid developer is supplied from a mixer to a developing apparatus through a supply pipe to be provided for development. Then, the liquid developer that is not provided for the development is collected in the mixer by being discharged from a discharge pipe of the developing apparatus, and is reused by being supplied from the mixer to the developing apparatus again. That is, the liquid developer circulates between the developing apparatus and the mixer.

In the image forming apparatus, from the viewpoint of maintenance, the developing apparatus is detachably provided in an apparatus body. Therefore, a connection unit having a connection section for connecting the discharge pipe fixed to the developing apparatus to be insertable and extractable is provided in the apparatus body. Then, in an apparatus disclosed in U.S. Pat. No. 6,125,254, an opening and closing member for opening and closing a liquid discharge port is provided at a tip end of the discharge pipe such that the liquid developer does not leak from the discharge pipe when the developing apparatus is attached and detached. Further, in the apparatus disclosed in U.S. Pat. No. 6,125,254, in order to discharge the liquid developer from the discharge pipe by the gravity, the discharge pipe is inclined downward in a gravity direction.

As in the apparatus disclosed in U.S. Pat. No. 6,125,254, when the discharge pipe is inclined, a projected area of the developing apparatus including the discharge pipe is larger than the projected area when the discharge pipe is not inclined, which is contrary to the recent demand for downsizing the apparatus. Therefore, in order to reduce the projected area of the developing apparatus, it is considered that the discharge pipe extends in a substantially horizontal direction without being inclined. However, if the discharge pipe extends in a substantially horizontal direction, when the liquid developer circulates, a part of the liquid developer discharged from the discharge pipe flows in a direction opposite to an insertion direction along the surface of the discharge pipe, is permeated in a gap between the discharge pipe and the connection unit, and leaks from the gap in some cases.

### SUMMARY OF THE INVENTION

According to one aspect of the present invention, an image forming apparatus includes a liquid discharge unit configured to be attachable to and detachable from an apparatus body, the liquid discharge unit including, a accommodating container configured to accommodate liquid developer including a toner and carrier liquid, and a discharge pipe portion having a liquid discharge port through which the liquid developer in the accommodating container is discharged; and a connection unit including: an insertion portion into which the discharge pipe portion is inserted in an insertion direction intersecting a gravity direction; a liquid receiving portion configured to receive the liquid developer falling from the liquid discharge port of the discharge pipe portion; and an abutment member disposed on the upstream of the liquid discharge port of the discharge pipe portion in the insertion direction and abut on at least the surface of the discharge pipe portion from below in the gravity direction, wherein a side surface of the abutment member on a downstream side in the insertion direction forms a guide surface configured to guide the liquid developer to the liquid receiving portion.

Further features of the present invention will become apparent from the following description of exemplary embodiments with reference to the attached drawings.

### BRIEF DESCRIPTION OF THE DRAWINGS

FIG. 1 is a schematic view illustrating a configuration of an image forming apparatus according to the present embodiment.

FIG. 2 is a sectional view illustrating a configuration of a developing apparatus.

FIG. 3 is a schematic view illustrating a circulation path of a liquid developer.

FIG. 4 is a perspective view illustrating a configuration of an opening and closing member.

FIG. 5 is a sectional view illustrating a state in which the developing apparatus is mounted on a connection unit according to a first embodiment.

FIG. 6A is a sectional view illustrating a state immediately after a discharge pipe is inserted into the connection unit in the first embodiment.

FIG. 6B is a partially enlarged view illustrating the vicinity of an abutment member immediately after the discharge pipe is inserted into the connection unit in the first embodiment.

FIG. 7 is a sectional view illustrating a state immediately before an opening and closing member moves from a closed position to an open position in the first embodiment.

FIG. 8 is a perspective view illustrating a configuration of the connection unit according to a second embodiment.

FIG. 9 is a perspective view illustrating a state in which the developing apparatus is mounted on the connection unit in the second embodiment.

FIG. 10A is a sectional view illustrating a state immediately after the discharge pipe is inserted into the connection unit in the second embodiment.

FIG. 10B is a partially enlarged view illustrating the vicinity of the abutment member immediately after the discharge pipe is inserted into the connection unit in the second embodiment.

FIG. 11 is a schematic view for illustrating a swinging operation of the developing apparatus.

FIG. 12 is a schematic view illustrating a state of the connection unit immediately after the developing apparatus is mounted.

FIG. 13 is a schematic view illustrating a state of the connection unit after the developing apparatus is swung.

### DESCRIPTION OF THE EMBODIMENTS

### First Embodiment

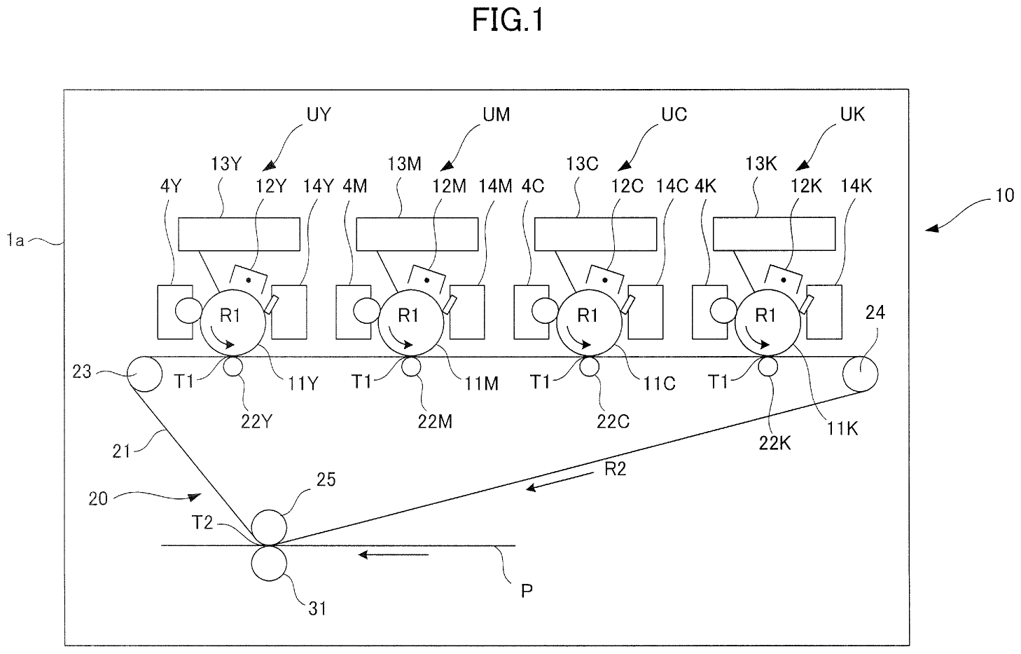

A first embodiment will be described. First, a schematic configuration of an image forming apparatus will be described with reference to FIG. 1. An image forming apparatus 10 illustrated in FIG. 1 is an intermediate transfer type full color printer having a tandem configuration in which a plurality of image forming units UY, UM, UC, and UK are arranged. In the present embodiment, an intermediate transfer unit 20 is disposed adjacent to the image forming units UY to UK below the plurality of image forming units UY to UK in the gravity direction.

The intermediate transfer unit 20 includes an intermediate transfer belt 21, primary transfer rollers 22Y to 22K, a drive roller 23, a tension roller 24, and a secondary transfer inner roller 25. The intermediate transfer belt 21 is supported over a roller such as the drive roller 23, the tension roller 24, and the secondary transfer inner roller 25, and is driven by the drive roller 23 to rotate in a direction of arrow R2 of FIG. 1.

The image forming units UY to UK are arranged along a movement direction (a direction of arrow R2 of FIG. 1) of the intermediate transfer belt 21. In the image forming unit UY, a yellow toner image is formed on a photosensitive drum 11Y and is transferred to the intermediate transfer belt 21. In the image forming unit UM, a magenta toner image is formed on a photosensitive drum 11M and is transferred to the intermediate transfer belt 21. In the image forming units UC and UK, a cyan toner image and a black toner image are formed on photosensitive drums 11C and 11K, respectively, and are transferred to the intermediate transfer belt 21. The four-color toner images transferred to the intermediate transfer belt 21 are conveyed to a secondary transfer unit T2 and are collectively transferred to a recording material P (for example, a sheet material such as a paper sheet and an OHP sheet).

The image forming units UY to UK have substantially the same configuration except that colors of toners used in developing apparatuses 4Y, 4M, 4C, and 4K are yellow, magenta, cyan, and black, which are different from each other. Therefore, in the following, in a state in which the characters Y, M, C, and K at ends of the reference numerals for distinguishing the image forming units UY, UM, UC, and UK are omitted, the configuration and the operation of the image forming units UY to UK will be described.

A charging device 12, an exposing device 13, a developing apparatus 4, and a cleaning device 14 are arranged in the image forming unit U to surround a photosensitive drum 11 as an image bearing member. The image forming unit U is disposed at a position where the photosensitive drum 11 faces the primary transfer roller 22 with the intermediate transfer belt 21 interposed therebetween, such that a primary transfer unit T1 of a toner image is formed by a primary transfer roller 22 between the photosensitive drum 11 and the intermediate transfer belt 21. The photosensitive drum 11 has a photosensitive layer formed on an outer circumferential surface of an aluminum cylinder and is rotated in a direction of arrow R1 of FIG. 1 at a predetermined process speed.

The charging device 12 charges the photosensitive drum 11 to a uniform negative dark potential by, for example, irradiating charged particles accompanying corona discharge. The exposing device 13 records an electrostatic latent image of an image on the charged surface of the photosensitive drum 11 by scanning, with a rotating mirror, a laser beam obtained by ON-OFF modulation of scanning line image data obtained by developing a decomposed color image of each color. The electrostatic latent image is developed as a toner image by the developing apparatus 4.

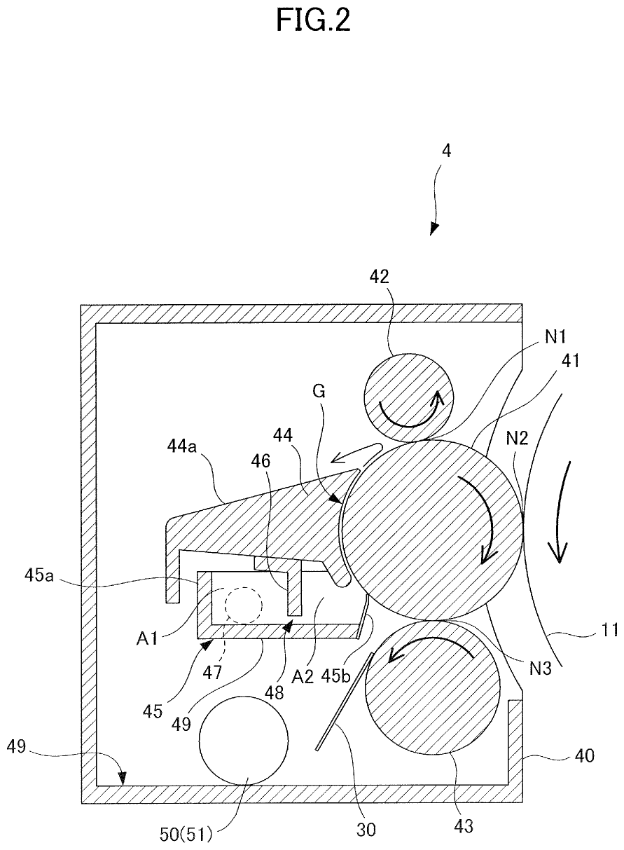

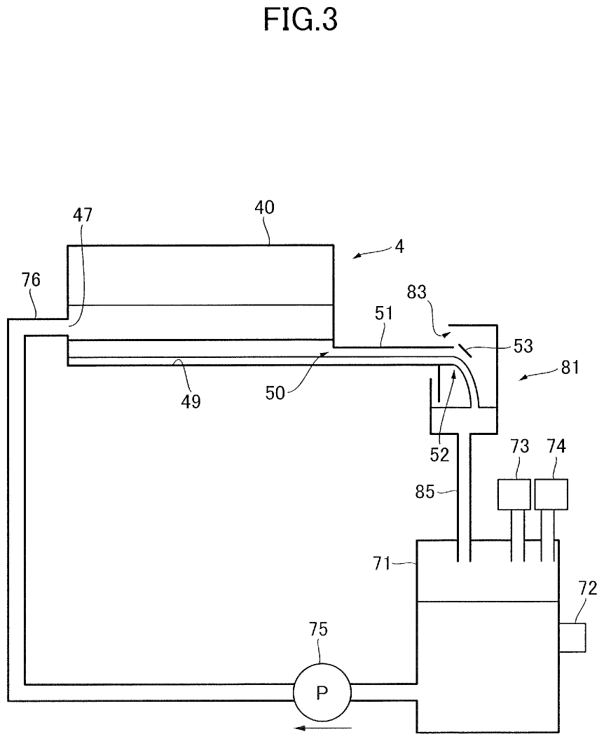

The developing apparatus 4 contains a liquid developer in which a powder toner that is a dispersoid is dispersed in carrier liquid that is a dispersion medium, and the developing apparatus 4 performs development using the liquid developer. Then, in the case of the present embodiment, the developing apparatus 4 as a liquid discharging unit that can accommodate and discharge the liquid developer is detachably provided in an apparatus body 1a and is mounted adjacent to the intermediate transfer unit 20 above the intermediate transfer unit 20 in the gravity direction. The developing apparatus 4 will be described below (see FIGS. 2 and 3).

Further, in the following description, a front surface side refers to the front side of the developing apparatus 4 in a mounting direction, and a rear surface side refers to a rear side of the developing apparatus 4 in the mounting direction. In the case of FIGS. 1 and 2, the front direction of the drawings corresponds to the front surface side. Further, in the following description, an upper side and a lower side refer to an upper side in the gravity direction and a lower side in the gravity direction, respectively.

In the primary transfer unit T1 formed by the primary transfer roller 22, the toner image formed on the photosensitive drum 11 is primarily transferred to the intermediate transfer belt 21 using an electric field. The toner and the carrier liquid remaining on the photosensitive drum 11 after the primary transfer are collected by the cleaning device 14.

The secondary transfer unit T2 is a toner image transfer nip portion to the recording material P formed by abutting a secondary transfer outer roller 31 on the intermediate transfer belt 21 supported by a secondary transfer inner roller 25. In the secondary transfer unit T2, as a secondary transfer voltage is applied to the secondary transfer outer roller 31, the toner image is secondarily transferred from the intermediate transfer belt 21 to the recording material P conveyed to the secondary transfer unit T2. The toner and the carrier liquid remaining on the intermediate transfer belt 21 after the secondary transfer are collected by a belt cleaning device that is not illustrated.

The recording material P on which four-color toner images are secondarily transferred at the secondary transfer unit T2 is conveyed to a fixing device or the like that is not illustrated, and the toner image transferred to the recording material P is fixed by the fixing device or the like. The recording material P on which the toner image is fixed is discharged to an outside of the apparatus body.

### Developing Apparatus

The configuration and the developing operation of the developing apparatus 4 will be described with reference to FIG. 2. As illustrated in FIG. 2, the developing apparatus 4 includes a developing container 40 as an accommodating container, a developing roller 41, a squeeze roller 42, a cleaning roller 43, an electrode segment 44, a supply tray 45, a cleaning blade 30, and the like.

As illustrated in FIG. 2, a part of the developing container 40 facing the photosensitive drum 11 is opened, and the developing roller 41 is rotatably disposed such that a part of the developing roller 41 is exposed to an opening portion. The developing roller 41 is formed in a cylindrical shape and is rotated in the same direction on the surface thereof facing the photosensitive drum 11. On an opposite side to the surface of the developing roller 41 facing the photosensitive drum 11, the electrode segment 44 is disposed to face the photosensitive drum 11 with a gap G of a predetermined interval therebetween. The supply tray 45 is disposed below the electrode segment 44, and the liquid developer is drawn up from the supply tray 45 to the gap G by a rotational force of the developing roller 41. A flexible sheet member 45b formed using PET, urethane or the like is disposed on the developing roller 41 side of the supply tray 45 to abut on the developing roller 41.

The supply tray 45 temporarily accommodates the liquid developer supplied from a mixer 71 (see FIG. 3 described later) such that the developing roller 41 can draw up the liquid developer through rotation. The supply tray 45 has a supply port 47 on the front surface side thereof. Further, the supply tray 45 is transversely divided into an inflow chamber A1 far from the developing roller 41 and a supply chamber A2 close to the developing roller 41 by a partition plate 46 extending from a substantially central portion in a vertical direction of the drawing. The supply port 47 communicates with the inflow chamber A1. Then, a gap 48 is provided at a lower end of the partition plate 46 to cause the inflow chamber A1 and the supply chamber A2 to communicate with each other. The liquid developer supplied from the mixer 71 (see FIG. 3) flows from the supply port 47 into the inflow chamber A1. The liquid developer flowing into the inflow chamber A1 passes through the gap 48 to fill the supply chamber A2, and the liquid developer in the supply chamber A2 is drawn up to the gap G by the developing roller 41.

The amount of the liquid developer supplied from the mixer 71 (see FIG. 3) to the supply tray 45 is larger than the amount of the liquid developer drawn up to the gap G by the developing roller 41. In this way, the liquid level of the liquid developer in the supply tray 45 is not lowered to such an extent that it is difficult for the developing roller 41 to draw up. However, in this case, an extra liquid developer spills over a wall 45a far from the developing roller 41 and falls to a bottom portion 49 of the developing apparatus 4.

The electrode segment 44 forms an electric field between the electrode segment 44 and the developing roller 41. According to the electric field, the toner contained in the liquid developer drawn up to the gap G approaches a surface side of the developing roller 41. The squeeze roller 42 is disposed on the downstream side of the electrode segment 44 in a rotation direction of the developing roller 41. The squeeze roller 42 is in contact with the developing roller 41 to form a nip portion N1. Among the liquid developer on the developing roller 41 which has passed through an area facing the electrode segment 44, the toner that are collected on the surface of the developing roller 41 and a part of the carrier liquid pass through the nip portion N1. The liquid developer that has not passed through the nip portion N1 flows along an upper surface 44a of the electrode segment 44 and falls to the bottom portion 49 of the developing apparatus 4.

The toner and the carrier liquid that have passed through the nip portion N1 are conveyed to a developing nip portion N2 formed by the developing roller 41 and the photosensitive drum 11, so that the electrostatic latent image on the photosensitive drum 11 is developed into a toner image. The cleaning roller 43 is disposed on the downstream side of the developing nip portion N2 in the rotation direction of the developing roller 41. The cleaning roller 43 collects the toner remaining on the developing roller 41, which has passed through the developing nip portion N2, using an electrostatic force, and removes the carrier liquid remaining on the developing roller 41 by pressing in a collection nip portion N3. Then, the cleaning blade 30 is disposed on the downstream side of the collection nip portion N3 in a rotation direction of the cleaning roller 43. The cleaning blade 30 is an elastic member that abuts on the cleaning roller 43 in a longitudinal direction, and scrapes off the toner and the carrier liquid on the cleaning roller 43. The carrier liquid removed by the cleaning roller 43 and the toner and the carrier liquid scraped off by the cleaning blade 30 fall to the bottom portion 49 of the developing apparatus 4.

Liquid Developer

The liquid developer used in the developing apparatus 4 will be described. The toner contained in the liquid developer is a resin toner in which a colorant and a binder are the main components and a charging auxiliary agent or the like is added thereto. For example, the toner has an average particle diameter of 0.1 μm to 2 μm. Meanwhile, for example, the carrier liquid is a non-volatile liquid having a high resistance and a low dielectric constant, which has a volume resistivity adjusted to 1E+9 Ω□cm or more, a relative dielectric constant adjusted to 10 or less, and a viscosity adjusted to 0.1 cP to 100 cP. The carrier liquid may be a liquid in which an insulating solvent such as silicone oil, mineral oil, and Isopar M (a registered trademark, manufactured by ExxonMobil) is a main component and a charge control agent or the like is added thereto as needed. Further, a liquid monomer that is cured by ultraviolet rays may be used as long as the physical property values of the liquid monomer are within the above-described physical property values.

### Circulation Path of Liquid Developer

A circulation path of the liquid developer will be described with reference to FIG. 3. In FIG. 3, the developing apparatus 4 is detached from the apparatus body by moving from the right side to the left side in the drawing. That is, the left side of FIG. 3 corresponds to the front surface side.

The liquid developer circulates through a circulation path formed between the mixer 71 and the developing apparatus 4. In the case of the present embodiment, a pump 75 is used to supply the liquid developer to the developing apparatus 4, whereas gravity is used to discharge the liquid developer from the developing apparatus 4. Therefore, as illustrated in FIG. 3, a connection unit 81 and the mixer 71 are arranged below the developing apparatus 4.

The liquid developer is accommodated in the mixer 71 and is supplied from the mixer 71 via a supply pipe 76 to the developing apparatus 4. The supply pipe 76 is detachably attached to the supply port 47. The mixer 71 supplies the liquid developer to the developing apparatus 4 by the pump 75 serving as a delivery unit. The pump 75 can supply the liquid developer to the developing apparatus 4 by being energized by a power source that is not illustrated.

The mixer 71 mixes and disperses the toner in the carrier liquid at a predetermined ratio to generate the liquid developer. The carrier liquid is accommodated in a carrier tank 73 and the toner is accommodated in a toner tank 74. Then, the mixer 71 is provided with a concentration sensor 72 for detecting the toner density of the liquid developer in the mixer 71. According to the toner density detected by the concentration sensor 72, the carrier liquid is supplied from the carrier tank 73 to the mixer 71 and the toner is supplied from the toner tank 74 to the mixer 71. The mixer 71 stirs and mixes the supplied carrier liquid and the supplied toner to disperse the toner in the carrier liquid.

The liquid developer that has fallen to the bottom portion 49 of the developing apparatus 4 as described above returns from the developing apparatus 4 to the mixer 71 for reusing. For this purpose, for example, a cylindrical shape discharge pipe 51 is fixed to the developing apparatus 4 on the rear surface side of the developing container 40 opposite to the supply port 47. The discharge pipe 51 forms a discharge path through which the liquid developer in the developing container 40 is discharged. In the case of the present embodiment, a liquid discharge port 52 through which the liquid developer is discharged is formed at a tip end of the discharge pipe 51 in an insertion direction. In the case of the present embodiment, the insertion direction of the discharge pipe 51 coincides with a mounting direction of the developing apparatus 4.

In the present embodiment, the discharge pipe 51 communicates with the developing container 40 at a position closer to the bottom portion 49 below the supply port 47 and extends from the developing container 40 in a substantially horizontal direction. The reason why the discharge pipe 51 extends in a substantially horizontal direction is that a projected area of the developing apparatus 4 including the discharge pipe 51 from a rotational axis direction of the developing roller 41 (see FIG. 2) is minimized, particularly, the discharge pipe 51 is accommodated within the range of a projected area of the developing container 40. In this way, it is possible to reduce an occupation dimension of the developing apparatus 4 including a trajectory at the time of attachment and detachment. Thus, the mounting density of various devices such as the developing apparatus 4 and the photosensitive drum 11 in the apparatus body 1a (see FIG. 1) can be further increased. Accordingly, downsizing of the image forming apparatus can be realized. Further, the substantially horizontal direction means a direction that forms an angle of 5 degrees or less with respect to the horizontal plane. For example, the substantially horizontal direction is a direction that forms an angle of 5 degrees or less with respect to the plane (the horizontal plane) orthogonal to the gravity direction.

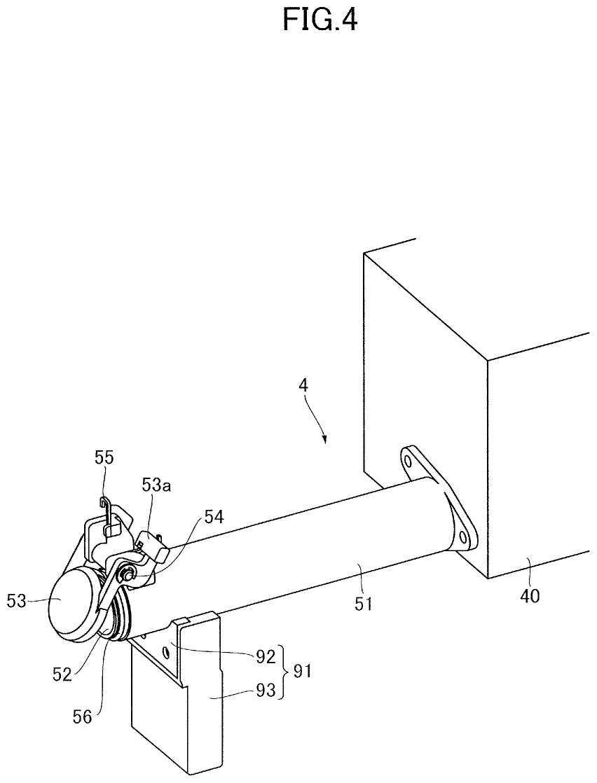

The liquid developer discharged through the discharge pipe 51 and the liquid discharge port 52 to the outside of the developing container 40 is temporarily accommodated in the connection unit 81 and is then sent to the mixer 71. The connection unit 81 is disposed between the developing apparatus 4 and the mixer 71 in the circulation path for liquid developer in order to receive the liquid developer discharged from the developing apparatus 4 and send the received liquid developer to the mixer 71. Although the connection unit 81 will be described below (see FIGS. 4 to 8), the developing apparatus 4 and the connection unit 81 are connected to each other to be able to transfer the liquid developer through the discharge pipe 51.

In the present embodiment, the developing apparatus 4 is provided to be attachable to and detachable from the front surface side with respect to the apparatus body 1a (see FIG. 1). For example, the developing apparatus 4 is held by the apparatus body 1a to be slidable via a pair of rail members (not illustrated) extending from the front surface side to the rear surface side. Accordingly, the developing apparatus 4 in a mounted state can be separated from the apparatus body 1a to be pulled out to the front surface side. When the developing apparatus 4 is separated, the developing apparatus 4 (specifically, the discharge pipe 51) and the connection unit 81 are separated from a connection section 83. Meanwhile, the developing apparatus 4 in an unmounted state can be mounted on the apparatus body 1a to be pushed into the rear surface side. When the developing apparatus 4 is mounted, the developing apparatus 4 (specifically, the discharge pipe 51) and the connection unit 81 are connected to each other through the connection section 83. It is obvious that when the developing apparatus 4 is separated, the pump 75 is stopped before the separation.

### Opening and Closing Cap

However, in a state in which the liquid developer remains in the developing container 40, when the developing apparatus 4 is separated, there is a possibility that the liquid developer in the developing container 40 is discharged from the discharge pipe 51 and flows out to the outside. To avoid this, before the developing apparatus 4 is separated, that is, before the discharge pipe 51 is separated from the connection section 83, the liquid discharge port 52 of the discharge pipe 51 may be closed. Then, in the present embodiment, an opening and closing cap 53 as an opening and closing member for opening and closing the liquid discharge port 52 is provided at the tip end of the discharge pipe 51 in the insertion direction.

The opening and closing cap 53 will be described with reference to FIG. 4. The opening and closing cap 53 is formed in a shape that is matched with the shape of the liquid discharge port 52. For example, when the liquid discharge port 52 is formed in a circular shape, the opening and closing cap 53 is also formed in the circular shape. As illustrated in FIG. 4, the opening and closing cap 53 is held by a lever member 53a that is provided to be pivotable about a shaft 54 by a spring 55. The spring 55 and the lever member 53a are parts of an opening and closing mechanism. The spring 55 is, for example, a torsion coil spring, and urges the lever member 53a in a direction in which the opening and closing cap 53 is closed. The opening and closing cap 53 pivots about the shaft 54 to move between an open position where the liquid discharge port 52 is opened and a closed position where the liquid discharge port 52 is closed. That is, when the discharge pipe 51 is removed, the opening and closing cap 53 is operated to close the liquid discharge port 52, and when the discharge pipe 51 is inserted, the opening and closing cap 53 is operated to open the liquid discharge port 52. Then, a rubber ring 56 is disposed as a seal member at the tip end of the discharge pipe 51. When the opening and closing cap 53 is closed, the rubber ring 56 prevents leakage of the liquid developer from the discharge pipe 51 by being sandwiched between the opening and closing cap 53 and the discharge pipe 51. In this way, as the liquid discharge port 52 of the discharge pipe 51 is opened and closed by the opening and closing cap 53, the liquid developer is prevented from leaking from the discharge pipe 51 at the time of attachment and detachment of the developing apparatus 4.

### Connection Unit

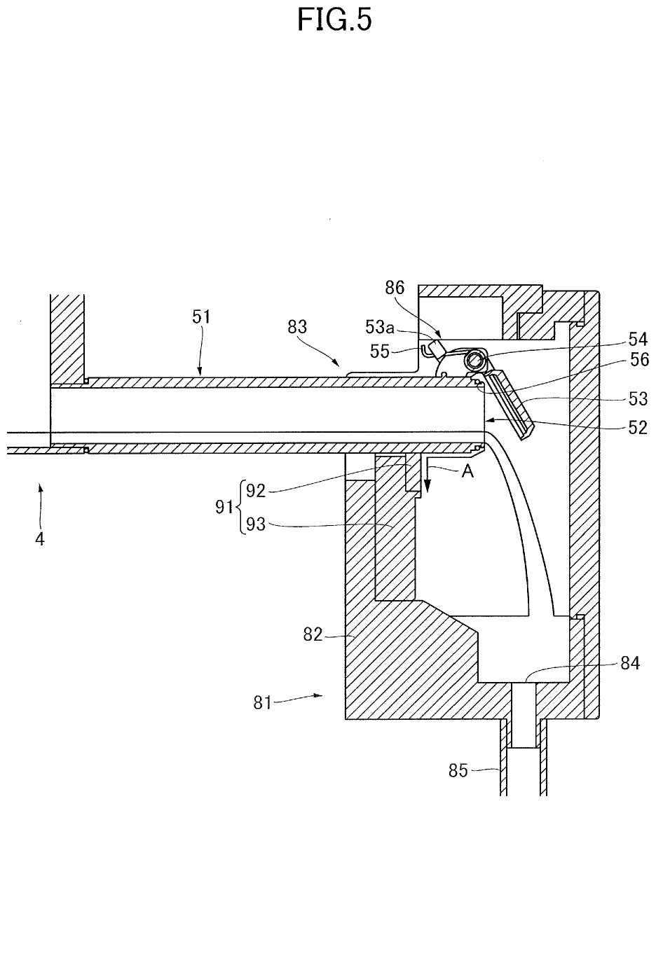

The connection unit 81 of the first embodiment will be described with reference to FIGS. 3 and 4 and with reference to FIGS. 5 to 7. As illustrated in FIG. 5, the connection unit 81 includes a casing 82 as a liquid receiving portion that can receive and accommodate the liquid developer discharged from the discharge pipe 51. The connection section 83 as an insertion portion into which the discharge pipe 51 can be inserted is formed on the upper side of the front surface side of the casing 82. Further, a liquid discharge port 84 is formed at the bottom portion of the casing 82 to discharge the liquid developer in the casing 82 by gravity. A tube 85 (or a pipe) is connected to the liquid discharge port 84. Since an opposite side to the tube 85 is connected to the mixer 71, the liquid developer in the casing 82 is sent to the mixer 71.

As described above, in the present embodiment, the discharge pipe 51 extends from the developing container 40 in a substantially horizontal direction. In this case, when the liquid developer circulates, a part of the liquid developer discharged from the liquid discharge port 52 moves from the rear surface side to the front surface side along the surface of the discharge pipe 51 on the lower side in a gravity direction (arrow A of FIG. 5). When liquid leakage occurs from a gap between the discharge pipe 51 and the connection section 83, the inside of the apparatus is contaminated.

### Abutment Member

Then, in the present embodiment, an abutment member 91 is provided in the connection unit 81 in order to collect, in the casing 82, the liquid developer transmitted on the surface of the discharge pipe 51. As illustrated in FIG. 4, the abutment member 91 is fixed to the casing 82 to abut on the surface of the discharge pipe 51 from below. Further, as illustrated in FIG. 5, the abutment member 91 abuts on the surface of the discharge pipe 51 upstream of the liquid discharge port 52 in the insertion direction in a state in which the discharge pipe 51 is completely inserted. In the case of the present embodiment, as indicated by arrow A of FIG. 5, the liquid developer flowing in a direction that is opposite to the insertion direction from the liquid discharge port 52 through the surface of the discharge pipe 51 is restricted from moving along the surface of the discharge pipe 51 by the abutment member 91. The liquid developer of which the movement is restricted flows downward along the surface of the abutment member 91, is joined to the liquid developer accommodated in the casing 82, and is collected.

The discharge pipe 51 is generally formed of a molded resin obtained by molding a resin into a cylindrical shape. Therefore, the surface of the discharge pipe 51 is likely to have unevenness. In this case, when the abutment member 91 is formed of a molded resin, a gap may be generated between the abutment member 91 and the discharge pipe 51 depending on contact between the abutment member 91 having slight unevenness on the surface thereof and the discharge pipe 51. Further, depending on accuracy of the discharge pipe 51 and the abutment member 91, the abutment member 91 and the discharge pipe 51 are not in close contact with each other, and thus the gap may be generated. When the gap is generated between the abutment member 91 and the discharge pipe 51, the movement of the liquid developer flowing along the surface of the discharge pipe 51 is not restricted, the liquid developer flows from the gap along the surface of the discharge pipe 51, and as a result, liquid leakage may occur.

In view of the above points, in the present embodiment, an abutment portion 92, as an end portion of the abutment member 91 which abuts on the surface of the discharge pipe 51, is formed of a sponge material such as flexible polyurethane foam. Then, a support member 93 which supports the abutment portion 92 is formed of a molded resin. In the case of the present embodiment, the support member 93 as a guide portion forms a guide surface that guides, into the casing 82, the liquid developer transmitted on the surface of the discharge pipe 51 of which the movement is restricted by the abutment portion 92. The abutment portion 92 is formed to have a length in the gravity direction of, for example, about 5 mm to 10 mm and to have a length in the insertion direction of, for example, about 3 mm to 5 mm. As the abutment portion 92 is formed using a flexible material, the abutment member 91 can be in close contact with and abut on the surface of the discharge pipe 51. In this case, even when unevenness occurs on the surface of the discharge pipe 51, the gap is difficult to occur between the abutment member 91 and the discharge pipe 51. Thus, the liquid developer flowing along the surface of the discharge pipe 51 is difficult to leak to the outside.

It is preferable that the shape of the abutment portion 92 is formed along the shape of the surface of the discharge pipe 51 on the lower side in the gravity direction. Further, the abutment portion 92 is formed to abut on the surface of the discharge pipe 51 in a predetermined range in the horizontal direction perpendicular to the insertion direction including at least a lower end in the gravity direction below the center of the discharge pipe 51. That is, the abutment portion 92 is formed to abut on the surface of the discharge pipe 51 along a circumferential direction. For example, when the discharge pipe 51 is formed in a cylindrical shape, the upper side of the abutment portion 92 is formed in an arc shape.

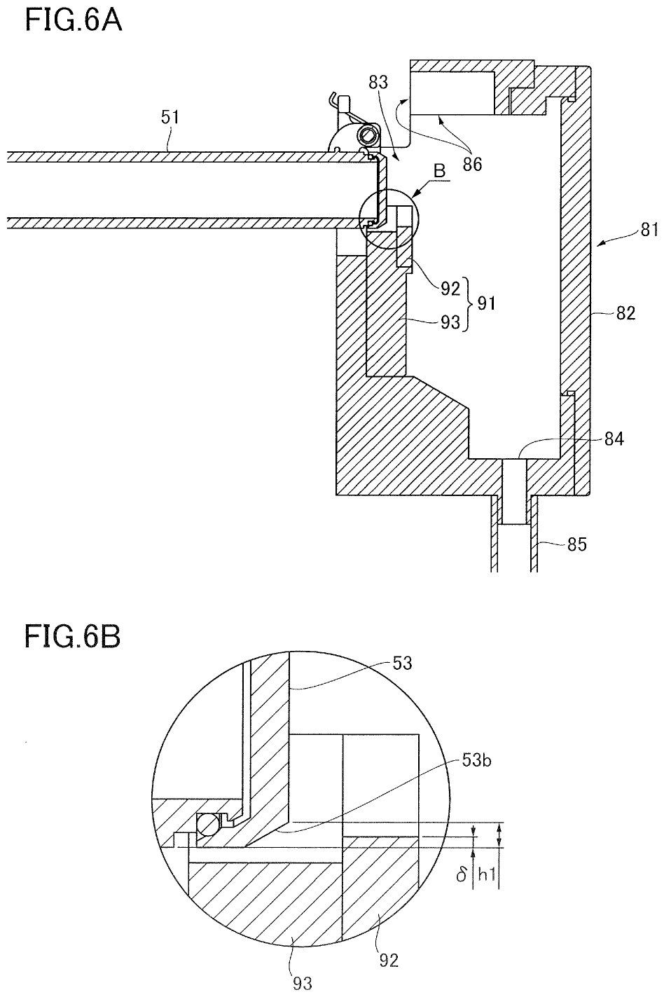

FIG. 6A illustrates a state immediately after the discharge pipe 51 is inserted into the connection unit 81 (specifically, the connection section 83). The connection section 83 is formed with a pressing portion 86 as a part of the opening and closing mechanism for opening and closing the opening and closing cap 53. When the discharge pipe 51 is inserted, the pressing portion 86 comes into contact with the lever member 53a of the opening and closing cap 53. Then, the lever member 53a is pressed down against an urging force of the spring 55, and the opening and closing cap 53 moves from the closed position (see FIG. 6A) to the open position (see FIG. 5). At this time, the abutment member 91 does not abut on the discharge pipe 51.

As illustrated in FIG. 6B, a tapered surface 53b inclined such that the diameter thereof on the rear surface side is smaller than the diameter thereof on the front surface side is formed at a peripheral portion of the opening and closing cap 53. This is for preventing damage, such as turning up, of the abutment portion 92 generated as the opening and closing cap 53 abuts on the abutment portion 92 when the discharge pipe 51 is inserted. The height (h1 in the drawing) of the tapered surface 53b in the gravity direction is set to be larger than the intrusion amount (δ in the drawing) of the abutment portion 92 in a state in which the abutment portion 92 does not abut on the discharge pipe 51. For example, the intrusion amount of the abutment portion 92 is set to 0.8 mm and the height of the tapered surface 53b in the gravity direction is set to 1.7 mm.

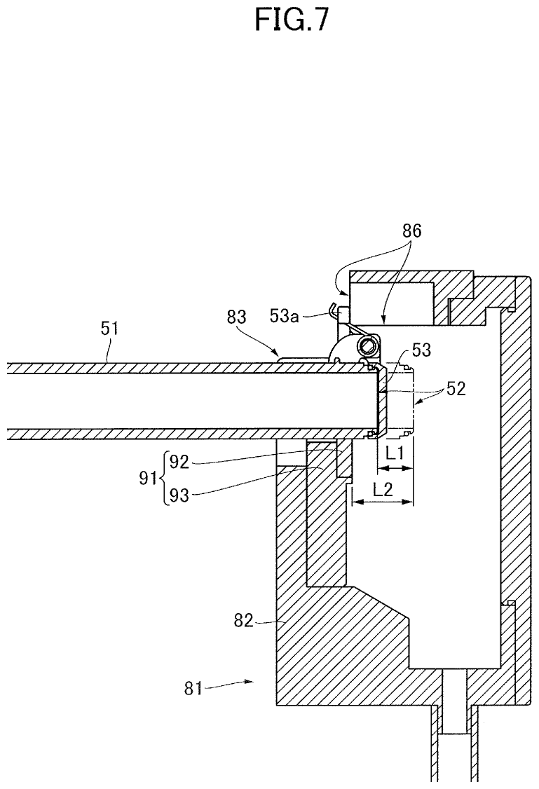

FIG. 7 illustrates a state immediately before the opening and closing cap 53 moves from the closed position to the open position. In FIG. 7, the position of the liquid discharge port 52 of the discharge pipe 51 in a state in which the discharge pipe 51 is completely inserted is indicated by a two-dot chain line. A movement length indicated by “L1” in the drawing is required as a movement length of the discharge pipe 51 required for the discharge pipe 51 to move from the start to the completion of the movement of the opening and closing cap 53 to the open position according to the insertion operation of the discharge pipe 51. Then, a length from a downstream end of the liquid discharge port 52 in the insertion direction to a downstream end of the abutment member 91 (specifically, the abutment portion 92) in the insertion direction at a time point when the opening and closing cap 53 is completely moved to the open position is set as “L2”.

When the discharge pipe 51 is inserted, if the opening and closing cap 53 is not located at the closed position until the liquid discharge port 52 passes through the abutment member 91, the liquid leakage may occur. In contrast, when the discharge pipe 51 is removed, if the opening and closing cap 53 is not completely moved to the closed position before the liquid discharge port 52 passes through the abutment member 91, the liquid leakage may occur. Then, in the present embodiment, the length L2 from the liquid discharge port 52 to the abutment member 91 at a time point when the opening and closing cap 53 is located at the open position is set to be larger than the movement length “L1” of the discharge pipe 51 for the opening and closing operation of the opening and closing cap 53. That is, the relationship “L2>L1” is satisfied. Accordingly, the liquid leakage from the discharge pipe 51, caused as the opening and closing cap 53 is moved to the open position while the discharge pipe 51 is inserted or extracted, is prevented.

As described above, when the discharge pipe 51 fixed to the developing apparatus 4 is inserted into and extracted from the connection unit 81 (the connection section 83), the abutment member 91 that abuts and slides on the surface of the discharge pipe 51 and can maintain a state in which the abutment member 91 abuts on the surface of the discharge pipe 51 after the insertion is provided in the connection unit 81. The abutment member 91 is in close contact with and abuts on the discharge pipe 51 from below in the gravity direction inside the casing 82 of the connection unit 81. That is, after the discharge pipe 51 is inserted, the state in which the abutment member 91 abuts on the surface of the discharge pipe 51 is maintained. Accordingly, when the liquid developer circulates, even if a part of the liquid developer discharged from the liquid discharge port 52 of the discharge pipe 51 flows along the surface of the discharge pipe 51, the liquid developer is guided and collected inside the casing 82 by the abutment member 91. Thus, it is difficult for the liquid developer to leak from the gap between the discharge pipe 51 and the connection section 83.

Further, the discharge pipe 51 is inserted and extracted while abutting on the abutment member 91. Thus, when the discharge pipe 51 is inserted and extracted, for example, even if the liquid developer remains on the surface of the discharge pipe 51, the liquid developer is removed from the surface of the discharge pipe 51 by the abutment member 91 and is collected in the casing 82. That is, even when the discharge pipe 51 is inserted and extracted, the liquid developer does not leak to the outside. Further, as the abutment portion 92 is formed along the shape of the surface of the discharge pipe 51 on the lower side in the gravity direction, resistance due to friction can be reduced when the discharge pipe 51 is inserted and extracted, and thus the discharge pipe 51 can be easily inserted and extracted.

### Second Embodiment

A second embodiment will be described. In the above-described first embodiment, the configuration in which the abutment member 91 is fixed to the inside of the casing 82 has been described. On the other hand, a connection unit 81A of the second embodiment has a configuration in which an abutment member 911 can move inside the casing 82. In the connection unit 81A of the second embodiment, firstly, the abutment member 911 is configured to reciprocate in the vertical direction, and secondly, the abutment member 911 is configured to be movable. The other configurations and operations are the same as those according to the first embodiment. Therefore, in the following, the same components as those according to the first embodiment will be designated by the same reference numerals, description thereof will be omitted and simplified, and description will be mainly made on differences from the first embodiment.

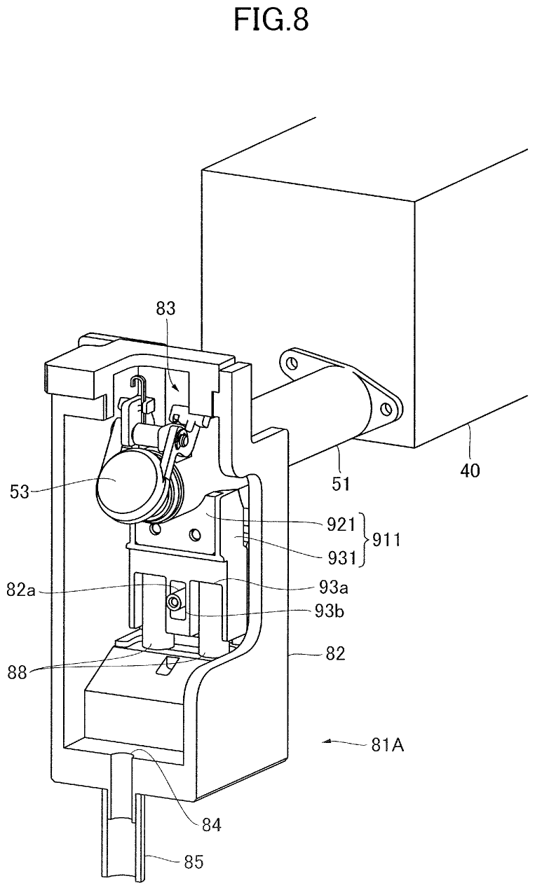

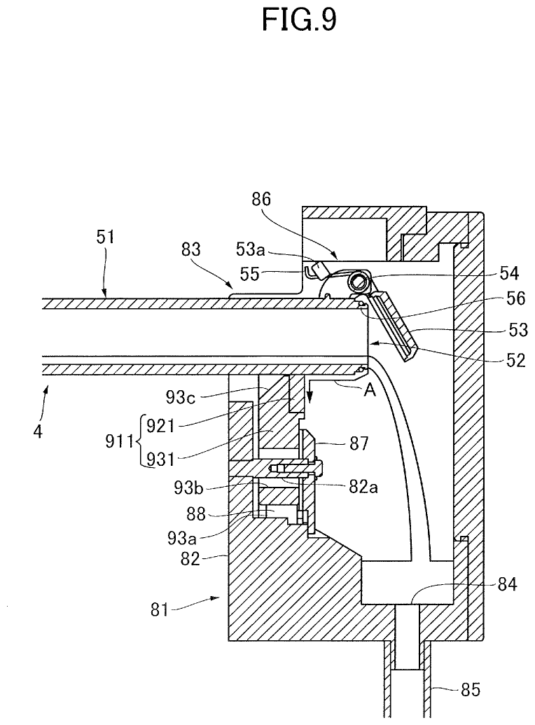

First, a case where the abutment member 911 is configured to reciprocate in the vertical direction will be described with reference to FIGS. 8 to 10B. As illustrated in FIGS. 8 and 9, the abutment member 911 includes a flexible abutment portion 921 and a support member 931 supporting the abutment portion 921 and formed of a molded resin. The support member 931 is formed with a pair of arrangement grooves 93a and a locking hole 93b.

A pair of springs 88 (for example, compression springs) as urging units are arranged below the support member 931, and these springs 88 are accommodated in the arrangement grooves 93a and urge the support member 931 upward, that is, toward the connection section 83. The locking hole 93b is formed in a vertically long shape that is long in the vertical direction and short in the horizontal direction, and has a horizontal width that is substantially the same as the diameter of a shaft 82a. The shaft 82a fixed to the casing 82 is slidably locked in the locking hole 93b. Thus, movement of the abutment member 911 is restricted by the shaft 82a to be able to reciprocate inside the casing 82 in the vertical direction.

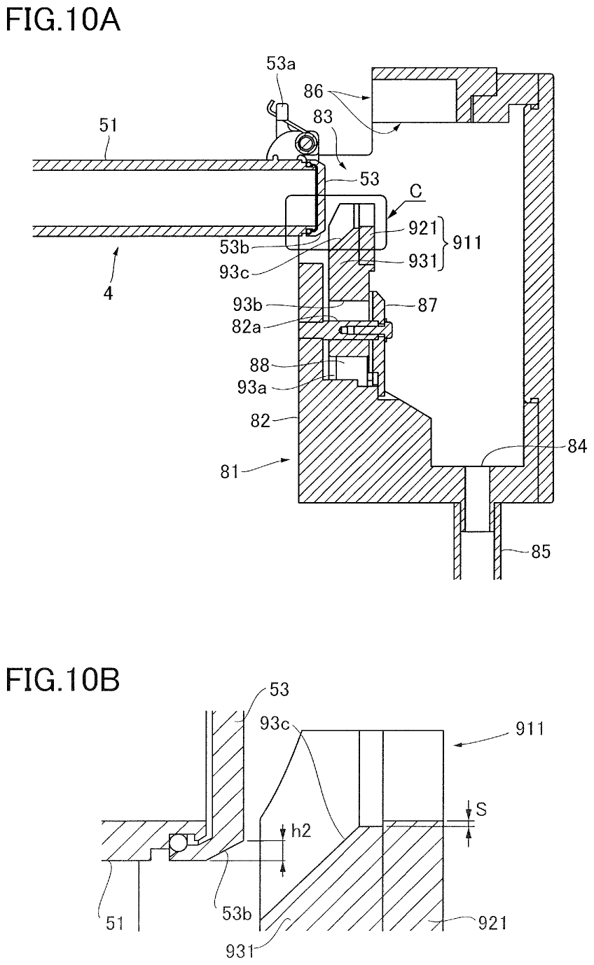

As illustrated in FIG. 10A, in a state in which the abutment member 911 is not in contact with the discharge pipe 51, the abutment portion 921 is located to be higher than a lower end of the discharge pipe 51 in the gravity direction by about 2 mm to 4 mm. Then, in a state in which the discharge pipe 51 is inserted, the abutment member 911 is pushed downward by the discharge pipe 51 against urging forces of the springs 88. Accordingly, while the abutment portion 921 and the discharge pipe 51 are in close contact with each other, the discharge pipe 51 is inserted and extracted. Further, after the discharge pipe 51 is inserted, a state in which the abutment member 911 abuts on the surface of the discharge pipe 51 is maintained.

Further, as illustrated in FIG. 10B, in the case of the present embodiment, a tapered surface 93c is formed on the front surface side of the support member 931. The tapered surface 93c is a surface that is inclined such that the height thereof on the rear surface side in the vertical direction is higher than the height thereof on the front surface side in the vertical direction. As the tapered surface 93c is formed on the support member 931, the abutment member 911 can be smoothly pushed down with the insertion of the discharge pipe 51. Further, even in the present embodiment, in order to prevent the abutment portion 921 from being turned over by the opening and closing cap 53, the height (h2 in the drawing) of the tapered surface 93c in the gravity direction is set larger than the intrusion amount (S in the drawing) of the abutment portion 921 in a state in which the tapered surface 93c does not abut on the discharge pipe 51. For example, the intrusion amount of the abutment portion 921 is set to 0.5 mm, and the height of the tapered surface 93c in the gravity direction is set to 1.7 mm.

Even in the present embodiment, after the discharge pipe 51 is inserted, a state in which the abutment member 911 is in contact with the surface of the discharge pipe 51 is maintained. Further, the discharge pipe 51 is inserted and extracted while being in contact with the abutment member 911. Accordingly, since the liquid developer flowing along the surface of the discharge pipe 51 is collected in the casing 82 by the abutment member 911, the same effect as that of the first embodiment described above that the liquid developer hardly leaks from the gap between the discharge pipe 51 and the connection section 83 can be obtained.

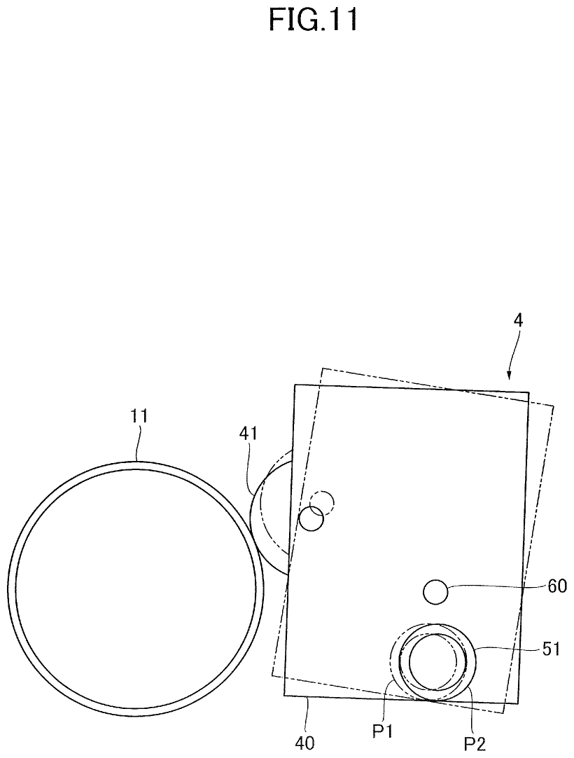

Next, a case where the abutment member 911 is configured to be movable will be described with reference to FIGS. 11 to 13. In the case of the image forming apparatus using a liquid developer, it has been known that generally, in order to suppress consumption of the carrier liquid, the developing roller 41 can be brought into contact with and be separated from the photosensitive drum 11. As an example of a configuration in which the developing roller 41 is brought into contact with and is separated from the photosensitive drum 11, as illustrated in FIG. 11, a configuration has been known in which the developing apparatus 4 is swung. In an example illustrated in FIG. 11, as the developing apparatus 4 swings about a pivot shaft 60, the developing roller 41 is brought into contact with and is separated from the photosensitive drum 11. A solid line of FIG. 11 indicates a state in which the developing roller 41 abuts on the photosensitive drum 11, and a two-dot chain line of FIG. 11 indicates a state in which the developing roller 41 is separated from the photosensitive drum 11.

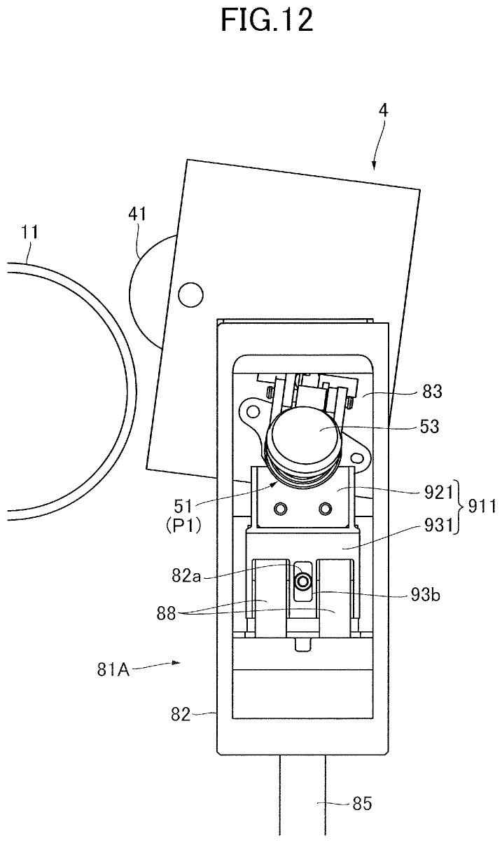

With a swinging motion of the developing apparatus 4, the discharge pipe 51 moves between a first position indicated by a symbol P1 and a second position indicated by a symbol P2 in FIG. 11. For example, the discharge pipe 51 moves in the horizontal direction by about 3 mm from the first position to the second position. When the discharge pipe 51 moves, if an abutment state between the discharge pipe 51 and the abutment member 911 (specifically, the abutment portion 921, see FIG. 12) is not maintained, the liquid leakage occurs due to the gap. Therefore, when the developing apparatus 4 swings, in order to maintain the abutment state between the discharge pipe 51 and the abutment member 911, the abutment member 911 moves following the movement of the discharge pipe 51.

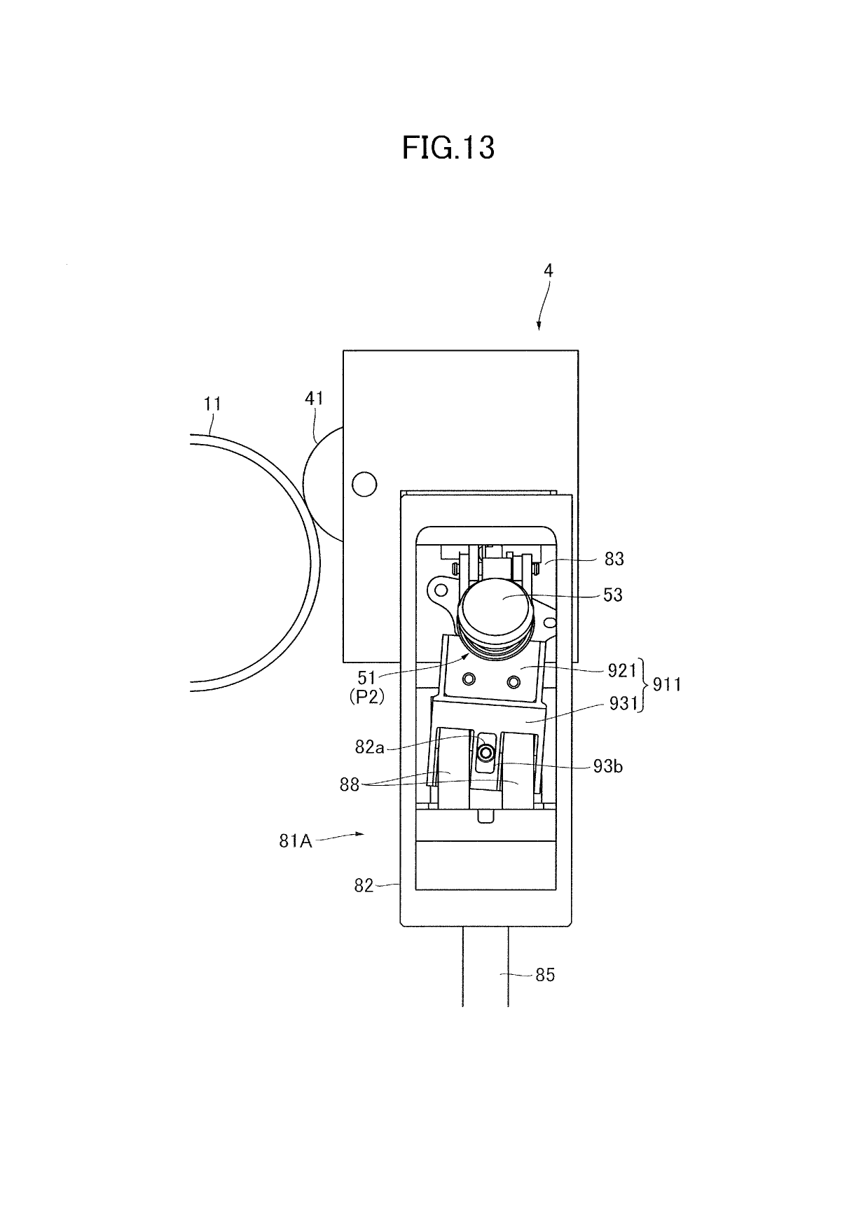

A state of the connection unit 81A immediately after the developing apparatus 4 is mounted (that is, before the developing apparatus 4 is swung) is illustrated in FIG. 12, and a state of the connection unit 81A after the developing apparatus 4 is swung is illustrated in FIG. 13. The connection unit 81A illustrated in FIGS. 12 and 13 has the same configuration as the above-described connection unit 81A illustrated in FIG. 8. Thus, herein, the description of the configuration will be omitted.

As described above, the support member 931 is urged toward the connection section 83 by the pair of springs 88 in a state in which the support member 931 is locked in the locking hole 93b by the shaft 82a serving as a holding member. Then, the support member 931 is locked to be swingable about the shaft 82a. Thus, the shaft 82a supports the abutment member 911 to follow the swinging of the developing apparatus 4 through the support member 931. In this case, when the developing apparatus 4 is not swung, as illustrated in FIG. 12, the abutment member 911 is pushed downward by the discharge pipe 51 in the gravity direction.

Then, when the developing apparatus 4 is swung to bring the developing roller 41 into contact with the photosensitive drum 11, as illustrated in FIG. 11, the discharge pipe 51 moves from the first position P1 to the second position P2 in the horizontal direction according to the swinging operation of the developing apparatus 4. As the discharge pipe 51 moves in the horizontal direction, the abutment member 911, which has been pushed down by the discharge pipe 51 downward in the gravity direction, swings to be shifted to an opposite side to the photosensitive drum 11 side. In this case, although the developing apparatus 4 is not inclined relative to the casing 82, the abutment member 911 is inclined relative to the casing 82. In this way, when the developing apparatus 4 is configured to be swingable, even if the discharge pipe 51 is shifted according to the swinging of the developing apparatus 4, the abutment member 911 is swung and followed. Accordingly, the abutment state between the abutment member 911 and the discharge pipe 51 is maintained, and the liquid developer that has flowed along the surface of the discharge pipe 51 by the abutment member 911 can be collected in the casing 82. Thus, the liquid developer hardly leaks from the gap between the discharge pipe 51 and the connection section 83. The configuration that enables the abutment member 911 to swing is not limited to the above-described configuration.

In the above-described embodiments, a case where the liquid developer is discharged from the developing apparatus 4 through the discharge pipe 51 is described as an example. However, the present invention is not limited thereto. For example, the present invention can be applied to various units that can accommodate and discharge the liquid developer, such as a photosensitive drum cleaner that removes the liquid developer on the photosensitive drum 11 and an intermediate transfer belt cleaner that removes the liquid developer on the intermediate transfer belt 21.

In the above-described embodiments, the image forming apparatus 10 has been described in which after toner images of respective colors are primarily transferred from the photosensitive drums 11Y to 11K of the respective colors to the intermediate transfer belt 21, composite toner images of the respective colors are collectively and secondarily transferred to the recording material P. However, the present invention is not limited thereto. The above-described embodiments can also be applied to, for example, a direct transfer image forming apparatus that directly transfers the toner image from the photosensitive drums 11Y to 11K to the recording material P carried and conveyed by a transfer material conveyance belt.

### OTHER EMBODIMENTS

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An image forming apparatus comprising:
a liquid discharge unit configured to be attachable to and detachable from an apparatus body, the liquid discharge unit including,
an accommodating container configured to accommodate liquid developer including a toner and carrier liquid, and
a discharge pipe portion having a liquid discharge port through which the liquid developer in the accommodating container is discharged; and
a connection unit including:
an insertion portion into which the discharge pipe portion is inserted in an insertion direction intersecting a gravity direction;
a liquid receiving portion configured to receive the liquid developer falling from the liquid discharge port of the discharge pipe portion; and
an abutment member disposed upstream of the liquid discharge port of the discharge pipe portion in the insertion direction and abut on at least the surface of the discharge pipe portion from below in the gravity direction,
wherein a side surface of the abutment member on a downstream side in the insertion direction forms a guide surface configured to guide the liquid developer to the liquid receiving portion.

2. The image forming apparatus according to claim 1, wherein
the discharge pipe portion is provided substantially in a horizontal direction in a state in which the discharge pipe portion is inserted in the insertion portion.

3. The image forming apparatus according to claim 1, wherein
the abutment member abuts on the discharge pipe portion in a state in which at least a part of the discharge pipe portion is inserted in the insertion portion.

4. The image forming apparatus according to claim 1, wherein
the discharge pipe portion is mounted on an upper end portion of the abutment member in the gravity direction.

5. The image forming apparatus according to claim 1, wherein
an end portion of the abutment member, which is in contact with a surface of the discharge pipe portion, is formed of a flexible member.

6. The image forming apparatus according to claim 1, wherein
the connection unit includes an urging unit that urges the abutment member toward the discharge pipe portion.

7. The image forming apparatus according to claim 1, wherein
the liquid discharge unit includes an opening and closing mechanism having an opening and closing member that is movable between an open position where the liquid discharge port of the discharge pipe portion is opened and a closed position where the liquid discharge port of the discharge pipe portion is closed, the opening and closing mechanism being configured to move the opening and closing member in response to insertion and extraction of the discharge pipe portion, and
the opening and closing mechanism moves the opening and closing member to start movement from the closed position to the open position after the liquid discharge port passes through the abutment member during an insertion operation of the discharge pipe portion and to complete the movement from the open position to the closed position before the liquid discharge port passes through the abutment member during an extraction operation of the discharge pipe portion.

8. The image forming apparatus according to claim 7, wherein
regarding the insertion direction of the discharge pipe portion, when a movement length by which the discharge pipe portion is moved from the start to the completion of the movement to the open position of the opening and closing member is L1 and a length from a downstream end of the liquid discharge port to a downstream end of the abutment member at a time point when the opening and closing member is completely moved to the open position is L2, a relationship of L2>L1 is satisfied.

9. The image forming apparatus according to claim 1, wherein
the liquid discharge unit is provided to be swingable with respect to the connection unit, and
the connection unit includes a holding member configured to hold the abutment member so as to follow a swinging operation of the liquid discharge unit.

10. The image forming apparatus according to claim 1, further comprising:
an image bearing member on which an electrostatic latent image is formed; and
a developing apparatus provided to be attachable to and detachable from the apparatus body and configured to develop the electrostatic latent image formed on the image bearing member into a toner image using the liquid developer containing the toner and the carrier liquid, wherein
the developing apparatus includes the liquid discharge unit.
